(19) United States
(12) Patent Application Publication
(10) Pub. No.: US 2004/0243751 A1
(43) Pub. Date: Dec. 2, 2004

(54) Method for resource access co-ordination in a data processing system, data processing system and computer program

(76) Inventor: Giovanni Rabaioli, Hohenkirchen-Siegertsbrunn (DE)

Correspondence Address: Siemens Corporation, Intellectual Property Department, 170 Wood Avenue South, Iselin, NJ, 08830, US

(21) Appl. No.: 10/491,073

(22) PCT Filed: Sep. 23, 2002
(86) PCT No.: PCT/DE02/03588

(30) Foreign Application Priority Data
Sep. 28, 2001 (DE) 101 48 007.5

(51) Int. Cl. G06F 13/14

(52) U.S. Cl. 710/240

(57) ABSTRACT

During a request for access to a selected resource, by means of a first task, a type of access is allocated to the first task, and a control is carried out to check whether other tasks have access to the selected resource. If other tasks have access to the selected resource, the respective types of access are determined for the tasks. If other tasks have access to the selected resource, access to the selected resource is granted to the first task if the type of access of the first task and the other tasks is readable.

### CROSS REFERENCE TO RELATED APPLICATIONS

This application is the US National Stage of International Application No. PCT/DE02/03588, filed Sep. 23, 2002 and claims the benefit thereof. The International Application claims the benefits of German application No. 10148007.5 DE filed Sep. 28, 2001, both of the applications are incorporated by reference herein in their entirety.

### FIELD OF INVENTION

In data processing systems with a plurality of processors, tasks are generally subdivided into a plurality of parallel executable threads, thereby reducing the total computing time accordingly. Parallel tasks often access common system resources, such as memory devices or peripheral terminals. For this reason resource access coordination measures must be provided.

### BACKGROUND OF INVENTION

According to a known method of resource access coordination, critical areas for system resources are defined which are only accessible for one task. If a task accesses a critical area, other tasks subsequently requesting access to said critical area are placed in a wait state until the critical area is released for the relevant waiting task. The more tasks are placed in a wait state in the event of a resource access request, the less the actual paralleling of tasks, which means that the main advantages of multiprocessor data processing systems are not fully utilized.

One approach for improving the parallelability of tasks consists in limiting access times for critical areas. However, this has the effect of considerably increasing the number of resource access requests.

A known method of resource access coordination uses a “lock manager” which administers resource access control elements at operating system level as a resource access control device, said elements being assignable to a task and authorizing it to access a critical area. Resource access control elements of this kind are known as “mutexes”. If a “mutex” is assigned to a task, it possesses an exclusive access right to a critical area. If other tasks attempt to access this critical area, the critical area is identified as occupied and the other tasks requesting access to the critical area are placed in a wait state. However, resource access control elements, such as “mutexes”, provided by the operating system are not in unlimited supply. In addition, frequent use of resource access control elements administered by the operating system causes a sustained consumption of processor resources which are therefore no longer usable for other purposes.

### SUMMARY OF INVENTION

The object of the present invention is to specify a method for resource access coordination in a data processing system, a data processing system and a computer program which enable system resources to be used more efficiently.

This object is achieved according to the invention by a method having the features set forth in claim 1, a data processing system having the features set forth in claim 9 and a computer program having the features set forth in claim 10. Further developments of the method according to the invention are detailed in the dependent claims.

An essential aspect of the present invention is that if a first task requests read access to a selected resource and other tasks are likewise read -accessing the selected resource, access to the selected resource is granted to the first task. Access to the selected resource is preferably granted to the first task without the involvement of a resource access control device administering resource access control elements which are each assignable to a task and allow it exclusive access to the selected resource. This avoids the situation whereby tasks requesting read access to the selected resource are placed in a wait state even if one or more tasks are already only read-accessing the selected resource. In addition, mutual interference between the relevant tasks can be eliminated in such a case. On the other hand, granting a task access to a selected resource without involving a resource access control device means lower consumption of the compute capacity of the relevant data processing system.

### BRIEF DESCRIPTION OF THE DRAWINGS

The present invention will now be explained in greater detail with reference to an exemplary embodiment and the accompanying drawings in which:

FIG. 1 shows a data processing system with a plurality of processors,

FIG. 2 shows a flow chart for a method for resource access coordination,

FIG. 3 shows a supplement to the flow chart shown in FIG. 2,

FIG. 4 shows a state transition table for the flow chart according to FIG. 3,

FIG. 5 shows data objects administered by a resource access control device.

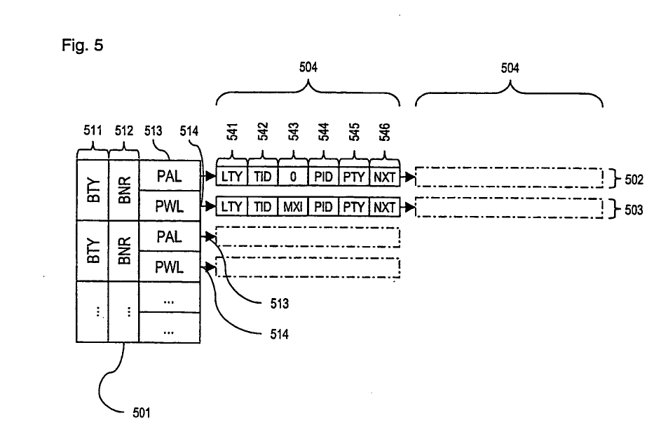

### DETAILED DESCRIPTION OF INVENTION

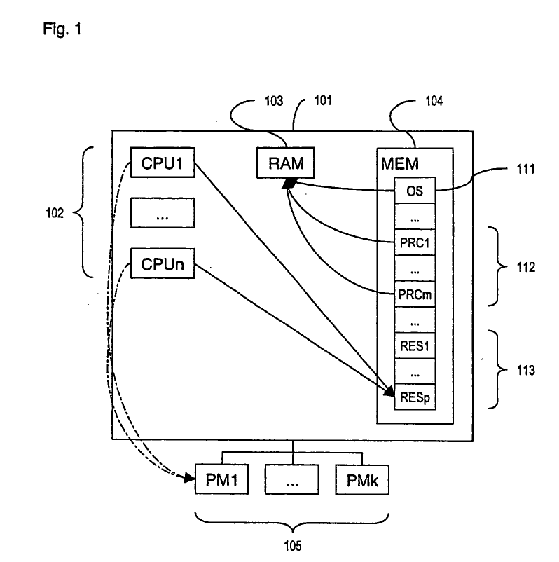

The data processing system 101 shown in FIG. 1 has a plurality of processors 102, a main memory 103, a nonvolatile memory 104 with memory areas 111 to 113 for an operating system, user programs as well as user data and peripheral terminals 105, such as printers, scanners or external storage media. As indicated by the arrows in FIG. 1, the operating system is loaded at least in part into the main memory 103. Also loaded into the main memory 103 are portions of code for executing tasks which are handled in parallel by the processors 102. The arrows from two processors 102 to a memory area 113 for user data in FIG. 1 indicate that two parallel tasks are requesting access to the same system resource. As indicated by the dash-dotted arrows in FIG. 1, a simultaneous request for a system resource provided by a peripheral terminal 105 is also conceivable. The following considerations apply equally to this case.

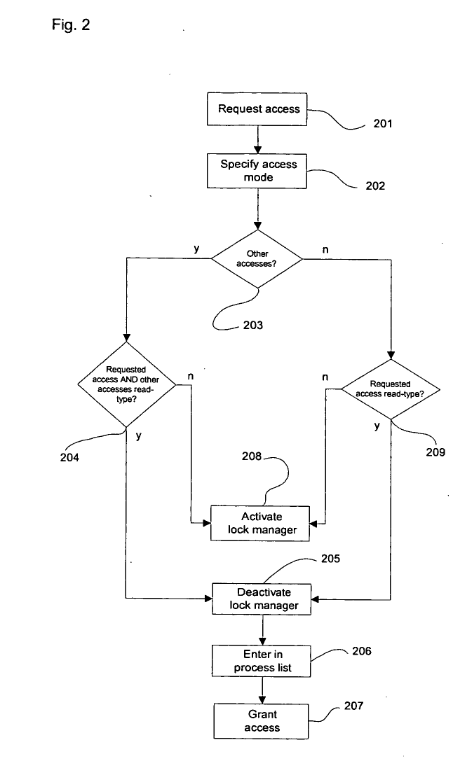

As shown in FIG. 2, on or after request 201 by a first task to access a selected resource, an access mode for said task i s specified 202. A check is now performed 203 to ascertain whether other tasks are accessing the selected resource.

If other tasks are accessing the selected resource, a check is performed 204 to ascertain whether the first task and the other tasks are re ad-accessing the selected resource. If this is not the case, the request by the first task to access the selected resource is handled by a resource access control device 208. This resource control access device administers resource access control elements assignable to a task and allowing said task exclusive access to the relevant selected resource. The resource access control device is, for example, a lock manager of an operating system, and the resource access control element is a mutex.

If the access mode of both the first task and of the other tasks is of the read type, the lock manager is deactivated 205, the first task is entered in a process list 206, and the first task is granted access to the selected resource 207. The process list is used to systematically record tasks bypassing the lock manager to read-access a selected resource for which at least one critical area has been defined. If no tasks other than the first task are accessing the selected resource, a check is performed 209 to ascertain whether the access mode of the first task is of the read type. If this is not the case, the lock managers 208 is activated for further resource access handling. If, on the other hand, the access mode of the task is of the read type, the lock manager is deactivated 205, the first task is entered in the process list 206 and the first task is granted access to the selected resource 207.

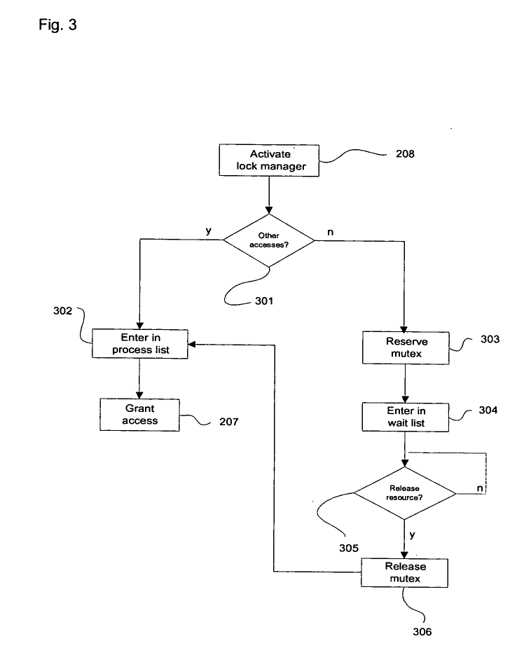

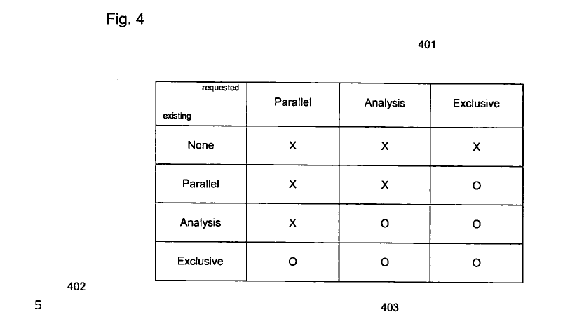

The handling of resource access requests by the lock manager after its activation 208 is shown in greater detail in FIG. 3. First a check is performed 301 to ascertain whether the resource access request is grantable. This check is performed using the state transition table shown in FIG. 4. Grantability of the relevant access requests can be inferred from an access mode 401 f or a task requesting resource access, and from access modes 402 for existing resource accesses of other tasks. For this purpose, entries 403 indicating the grantability of the relevant access request are assigned by the state transition table, in a matrix, to the access modes 401 for current access requests and the access modes 402 for already existing resource accesses. An entry with an “X” denotes that the access request is grantable, whereas an entry with an “O” denotes that the relevant access request is not grantable.

In FIG. 4 the access modes “PARALLEL”,“ANALYSIS” and “EXCLUSIVE” are used. The “PARALLEL” access mode means that access to a resource shared with other tasks is sufficient for a task requesting access to the relevant selected resource. This access mode is frequent particularly for tasks read-accessing a selected resource. The “ANALYSIS” access mode allows a task to access the relevant resource, undisturbed by tasks requesting write access, without preventing access for tasks requesting only read access to the relevant resource. The “EXCLUSIVE” access mode is used to grant a task exclusive access rights to a resource. This is the case for tasks requesting write access to the relevant resource.

If the request to access a selected resource is grantable for a task, said task is entered in an access list 302 which will be described in greater detail. Finally the task is granted access to the selected resource 207.

If a request to access a selected resource is not grantable for a task, an available mutex is reserved for said task 303. The task is subsequently entered in a wait list 304, which will be described in greater detail, and the task is placed in a wait state by the operating system. The task remains in this wait state until release of the selected resource which is continuously checked 305. If the previously locked resource is released, the mutex reserved for the task entered in the wait list is released 306 and the task is now entered in the access list 302. Finally access to the selected resource is granted 207.

The advantage of using a mutex for administering tasks entered in the wait list is that the consumption of a mutex as an operating system resource takes place at a point in time when the relevant task has to be placed in a wait state anyway by an operating system intervention. Moreover, the number of critical areas is generally much higher than the number of tasks in a wait state. The advantage of using mutexes for tasks in the wait state instead of for all the critical areas i s therefore that significantly fewer mutexes are used up. This in turn has the effect to reducing the consumption of available compute capacity by the operating system.

In order to coordinate memory resource accesses efficiently, it is advantageous for data to be uniformly identified. For this purpose the relevant physical storage medium is taken into account as the first identifier. It is additionally advantageous to subdivide the relevant storage medium into memory areas with defined length, hereinafter termed blocks. The relevant block number, which unambiguously designates a memory area and from which the relevant memory address can be deduced, is then used as the second identifier.

The data objects administered by the lock manager include a table 501 in which critical areas are recorded, the access list 502 and the wait list 503. The table 501 contains the block type 511 and the block number 512 of the relevant critical area as key fields. The table 501 additionally has a field 513 for a reference to the access list 502 and a field 514 for a reference to the wait list 503.

The access list 502 and the wait list 503 have entries 504 for the relevant tasks. The entries 504 for the tasks in the access list 502 and in the wait list 503 have an identical structure. Each entry 504 for a task has a field 541 for the relevant access mode and a field 542 with information about an assignment of the relevant task to a transaction. The advantage of a field 542 with information about a transaction is that a transaction constitutes a logical entity requiring consistent data. For this reason access locks are advisable for transactions. However, as a transaction constitutes a logical entity, it cannot be placed in a wait state in the event of a resource access request. This is only possible as a physical entity for the tasks assigned to the transaction.

In addition, an entry 504 for a task has a field 543 for a mutex identifier. In the access list 502 this field is empty, as no mutex is reserved for tasks already accessing a resource, as described above. An entry 504 for a task also contains a field 544 for a task identifier. There is additionally provided a field 545 for prioritizing the relevant task over the other tasks. On the basis of prioritizing one task over other tasks, the prioritized task can be given preference over other tasks entered in the wait list 503 when the selected resource becomes free. In addition, in each field 504 for a task there is provided a field 546 which refers to the next entry 504 for a task in the access list 502 or wait list 503.

The resource access coordination method described is particularly suitable for data processing systems in which read accesses clearly predominate over write accesses, since in the case of read accesses it is highly probable that activation of the lock manager can be dispensed with completely. This produces considerable advantages in respect of efficient utilization of computing capacities. Directory systems are an example of data processing systems in which read accesses are much more frequent than write accesses.

The described method for resource access coordination is implemented by a computer program which can be loaded into a main memory of a data processing system and has at least one portion of code on who se execution the above described steps of the resource access coordination method are performed when the computer program is run in a data processing system. In particular, the computer program monitors lock manager calls and if necessary deactivates the lock manager.

The present invention is not limited to the exemplary embodiment described here.

1-10 (canceled)

11. A method for resource access coordination in a data processing system, comprising:
specifying an access mode for a first task so that in the event of a request by the first task to access a selected resource, a check is performed to ascertain whether other tasks are accessing the selected resource;
determining relevant access modes for other tasks, if the other tasks are accessing the selected resource; and
granting access to the selected resource for the first task if the access mode of the first task and of the other tasks is of the read type, if other tasks are accessing the selected resource.

12. The method according to claim 11, wherein at least one area is defined for the selected resource.

13. The method according to claim 11, wherein requests by tasks to access selected resources are handled by a resource access control device which administers resource access control elements which are each assignable to a task and allow the task exclusive access to a selected resource, and wherein the resource access control device is deactivated if the access mode of the first task and of the other tasks is of the read type.

14. The method according to claim 13, wherein the resource access control device is a lock manager of an operating system, and wherein the resource access control element is a mutex.

15. The method according to claim 13, wherein, for the selected resource, a process list is generated into which tasks with read access mode are entered which access the selected resource with the resource access control device deactivated.

16. The method according to one of claim 13, wherein a check is performed by the resource access control device to ascertain whether the access requested is grantable, and wherein, if access is grantable, the relevant task is recorded in an access list and bypasses any assignment of a resource access control element to obtain access to the relevant selected resource, and wherein, if access is locked, the relevant task is recorded in a wait list and placed in a wait state.

17. The method according to claim 16, wherein a resource access control element is reserved for a task placed in a wait state.

18. The method according to claim 16, wherein an entry to an access list and/or wait list has information about the assignment of the relevant task to a transaction.

19. A data processing system, comprising:
a first task;
an access mode;
at least one device adapted to specify the access mode for the first task in the event of a request by a first task to access a selected resource, and of checking whether other tasks are accessing the selected resource;
at least one device adapted to determine the access mode for other tasks accessing the selected resource; and
at least one device adapted to grant access for the first task to the selected resource in the presence of other accessing tasks, if the access mode of the first task and of the other tasks is of the read type.

20. A computer program loadable into a main memory of a data processing system, comprising:
a plurality of processors;
a nonvolatile memory;
a plurality of peripheral terminals; and
at least one portion of code upon whose execution at least the following occurs:
in the event of a request by a first task to access a selected resource, an access mode is specified for said task and a check is performed to ascertain whether other tasks are accessing the selected resource;
in the event of other tasks accessing the selected resource, the relevant access modes are determined for said tasks; and
in the event of other tasks accessing the selected resource, access to the selected resource is granted for the first task if the access mode of the first task and of the other tasks is of the read type when the computer program is run in the data processing system.
